(19) United States
(12) Patent Application Publication
(10) Pub. No.: US 2005/0267887 A1
(43) Pub. Date: Dec. 1, 2005

(54) Computerized systems and methods for managing relationships

(76) Inventor: Duncan G. Robins, McKinleyville, CA (US)

Correspondence Address: KOLISCH HARTWELL, P.C., 520 S.W. YAMHILL STREET, SUITE 200, PORTLAND, OR, 97204, US

(21) Appl. No.: 11/139,286

(22) Filed: May 27, 2005

Related U.S. Application Data
(60) Provisional application No. 60/575,156, filed on May 27, 2004.

(51) Int. Cl. G06F 7/00

(52) U.S. Cl. 707/9

(57) ABSTRACT

Methods and systems for managing relationships and assisting relationship stewards in allocating resources among a plurality of steward-entity relationships. The methods and systems include allowing users to define steward-entity relationships and relationship tiers. Additionally, users assign relationship objectives to each relationship tier together with accommodation limits. The users then assign each of the steward-entity relationships to a relationship tier. This data and optionally data regarding interactions between entities and/or additional relationship data may be received by a computerized database and analyzed in a computerized system to produce one or more computerized relationship maps. The relationship maps may be used in whole or in part to provide feedback to one or more users regarding the steward-entity relationships.

### CROSS-REFERENCES

This application claims the benefit of U.S. Provisional Patent Application No. 60/575,156, titled “System and Method for Managing Relational Assets,” filed May 27, 2004, the entire disclosure of which is incorporated herein by reference for all purposes.

### FIELD OF THE INVENTION

The present disclosure is directed generally towards management of relationships and relational assets. More specifically, the present disclosure relates to computerized methods and systems of managing relationships.

### BACKGROUND

The business community and life generally has changed dramatically in the last several decades. Normal business practice used to require documents to be communicated via mail carriers with several days of delay. The fax machine and email have provided nearly instantaneous communication of documents. In days past, it was normal to be unreachable if you were out of the office. Now, due to cell phones, wireless email, and the like, the phrase ‘out of the office’ is often used to politely say that a person does not want to be reached. These advances in technology, facilitating communication and information flow, have changed the shape of business forever.

Additionally, advances in e-commerce and global shipping and manufacturing, as well as changes to international legal and trade systems have changed the nature of competition among businesses. No longer do business owners compete only with local or regional competitors. Manufacturers and service providers compete on a global scale within an ever changing marketplace to secure the competitive advantage needed to provide value to their employees, owners, and other stakeholders. Organizations that once were successful as monoliths of Corporate America are being forced to form new alliances and partnerships. Smaller organizations are finding the facilitated communication of the modern era allows them to cooperate, temporarily or long-term, with other organizations to gain additional competitive advantages and tap into resources previously unavailable to small organizations.

In order to succeed in this era of increased collaboration between organizations and entities and increased, and accelerated, communication between entities, organizations will need to adapt. They will need to break down the barriers between themselves and the rest of the world. They will need to build networks between themselves, their employees, and those with whom they interact. Additionally, they will need to facilitate communication and cooperation throughout these networks.

The organizational chart, such as the representative organizational chart shown in FIG. 1, is currently used to illustrate the flow of information and responsibility in many organizations. However, it is little more than a two-dimensional representation of the overt power structures operating in a company. The layers of management depicted by organizational charts are created for control, delineation of turf, and management of information flow. The linear nature of the flow of information, responsibility, and authority isolates individuals, prevents cooperation between entities and among different organizations, and contributes to negative competition as individuals or groups of individuals try to climb higher on the proverbial corporate ladder.

As seen in FIG. 1, organizational charts 10 are structured with head entity A at the top, indicated by reference numeral 12. Traditionally, the head entity 12 is the CEO, President, or other individual deemed to be the “head” of the organization. This head entity 12 often has several direct reports 14, such as direct reports B, C, D, E, and F, with whom the CEO or President communicates on a regularly basis. Additionally, each of the direct reports 14 may have their own reports 16, such as reports B1, B2, etc, which may also be referred to as employees 16.

In traditional organizations, employees 16 have very limited access to the head entity 12, except through their corresponding direct reports 14 that serve as their bosses or supervisors. Additionally, employees 16 serving under one direct report or supervisor 14, such as employees B1 and B2 serving under supervisor B, often have limited interaction with employees 16 serving under other supervisors 14, such as employees F1 and F2 serving under supervisor F.

As an example, direct report B may be the Vice President of Sales with sales people B1 and B2 reporting to him/her. Similarly, direct report F may be the Vice President of New Product Development with lab researchers F1 and F2 reporting to him/her. The traditional organizational chart enabled the sales people and the researchers to be very focused on their respective projects and to become specialized in their fields. However, organizations operating in this manner also experience hindered communication, collaboration, and innovation between the two groups of employees. Even in perfect organizations where information was not lost or misinterpreted as it passed up the chain and back down the chain, there was a time-delay due to the organization structure imposed by the organizational chart. And more frequently, the ideas of one set of employees would be lost or corrupted in the multi-step communication process.

Organizations now need to be much more fluid and relational than can be expressed in an organizational chart. Empowered teams and individuals need to make most of the decisions, and need the associated information and authority to do so in a timely manner. Boundaries between individuals, entities, and organizations and their surrounding worlds blur and change regularly as relationships, teams, partnerships, and cooperative ventures repeatedly form, function, accomplish, and dissolve with the ease of the modern communication structures. Organizations need a tool to represent and monitor how they create value from these relationships.

Effectively representing the relationships within and without an organization will enable an organization to naturally and effortlessly: 1) develop productive relationships that will stimulate creativity and team-based entrepreneurship while minimizing hierarchy and bureaucracy; 2) support fluid, proactive change and economic sustainability; and 3) represent all stakeholders appropriately despite the scarcity of time and resources. A tool for representing and monitoring relationships will enable an organization and its employees to see, graphically or textually, the correlation between their relationships, their efforts, and their results. This ability to receive feedback from the tool will enable organizations and their members to improve their allocation of time and resources to better support the relationships that help the organization accomplish its goals.

### SUMMARY

The present disclosure is directed toward a computerized method of managing relationships. The method may include identifying a plurality of entities and assigning an entity identifier to each one. One or more of the entities may be designated as relationship stewards by further assigning a steward identifier to those entities that are also stewards. Additionally, each relationship steward may be allowed to identify one or more entities with whom the steward has a relationship, thereby defining one or more steward-entity relationships. Accordingly, each steward will have some number of corresponding steward-entity relationships. In some applications of the present method, users other than relationship stewards may be able to identify relationships between two third-parties (i.e., relationships of which they do not form a part). Each steward-entity relationship, whether identified by a relationship steward or by another user, may be assigned a relationship identifier.

The methods of the present disclosure may also include defining two or more relationship tiers and assigning each tier a tier identifier. Furthermore, each relationship tier may be defined to include relationship objectives and may each accommodate a number of steward-entity relationships. Each relationship steward, or other user, may assign one or more of the steward-entity relationships to one of the two or more relationship tiers creating a relationship tier assignment for each relationship.

Additionally, the methods may include receiving one or more of the entity identifiers, the steward identifiers, the relationship identifiers, the tier identifiers, and the relationship tier assignments into a computerized database. The computerized database may reside on a single computer or server, or may be distributed over a networked computer system, such as on a plurality of computers and/or servers. A computerized system may analyze at least one or more of the entity identifiers, the steward identifiers, the relationship identifiers, the tier identifiers, and the relationship tier assignments to produce one or more relationship maps. In some applications of the present disclosure, the relationship map may be a planned map including relationships and objectives identified by the relationship stewards, a hypothetical map including relationships and objectives identified by another user such as a manager or an auditor, or an actual map including details about relationships from a historical perspective illustrating actual relationships. Based at least in part on one or more of the relationship maps, the methods of the present disclosure may provide feedback to at least one user selected from the group consisting of entities, relationship stewards, and other users, such as auditors.

The present disclosure is also directed toward relationship management systems configured to assist relationship stewards or other users in allocating resources among a plurality of steward-entity relationships. The relationship management systems according to the present disclosure may include at least one user interface system, at least one server system, and at least one computer network connecting the at least one user interface system and at least one server system.

The at least one user interface system may include a data input apparatus adapted to allow one or more users to input data,regarding at least one steward-entity relationship. The data input by the users may include information such as the name of the parties to the relationship, the positions of the parties, the type of relationship, the business objectives, etc. Additionally, the data input may include more detailed information such as transaction details, order history, interaction history, and may also include information such as notes about the relationship, or notes about the interactions within the relationship. The at least one user interface system may also include a data reporting apparatus adapted to display information regarding at least one steward-entity relationship, either as the information is input by the user or after some processing of the data to produce a report or other feedback for the user.

In some configurations of the relationship management systems according to the present disclosure, the server system may include at least one program and at least one database. The database may be adapted to receive data at least from the at least one user interface system. The database may further be adapted to store data including at least the data input by the one or more users through the at least one user interface systems.

As indicated, the server system may include at least one program. The at least one program may include multiple routines, such as a relationship identification routine and a relationship advisor routine. The relationship identification routine may be adapted to transmit instructions to at least one of the user interface systems instructing at least one of the users to identify at least one steward-entity relationship, to define two or more relationship tiers, to define relationship objectives for each tier, to define each tier as accommodating a number of steward-entity relationships, and to assign one or more of the steward-entity relationships to one of the two or more relationship tiers creating a relationship tier assignment for each relationship. The relationship advisor routine may be adapted to analyze the at least one steward-entity relationship, the two or more relationship tiers, the relationship objectives, and the relationship tier assignments for the steward-entity relationships to produce one or more relationship maps, selected from actual relationship maps, planned relationship maps, and hypothetical relationship maps. The relationship advisor routine may also be adapted to utilize the one or more relationship maps to prepare one or more relationship reports communicating feedback to a user, such as a relationship steward, relationship auditor, or other user. Accordingly, the relationship adviser routine may be further adapted to transmit the one or more relationship reports to at least one of the user interface systems for display on the data reporting apparatus to advise one or more users.

Similarly, the present disclosure is directed to computer-implemented systems in which relationships between entities are monitored and managed to assist relationship stewards and other users in allocating resources among a plurality of steward-entity relationships. The computer-implemented system may include a data input system, a monitoring system, a server system, and a reporting system.

The data input system of the computer-implemented systems may be adapted for entering information regarding a plurality of entities including one or more relationship stewards. Additionally, the data input system may include a relationship identification routine adapted to instruct at least one user to define at least one steward-entity relationship, to define two or more relationship tiers, to define relationship objectives for each tier, to define each tier as accommodating a number of steward-entity relationships, and to assign one or more steward-entity relationships to a relationship tier. The data input system may include any combination of components, such as keyboards, displays, touch-screen displays, or other data input components.

The monitoring system of the present disclosure may be adapted for collecting information regarding interactions between the plurality of entities, including interactions within one or more steward-entity relationships. The information collected could include any type of data to any degree of detail desired. In some applications of systems according to the present disclosure, the information collected may include interaction evaluation parameters for each interaction. The monitoring system, like the data input system, may include keyboards, displays, touch-screen displays, or other data input components. In some embodiments, the monitoring system may also include connections to other systems in an organization, such as ordering systems, customer service phone systems, and the like.

In computer-implemented systems according to the present disclosure, the server system may be configured to be in communication with the data input system and the monitoring system. The server system may include at least one program and at least one database adapted to receive, store, and access the information collected from the data input system and the monitoring system. In some configurations, the program may be adapted to prepare one or more relationship maps based at least in part on one or more factor, such as the defined relationship tiers, the relationship tier to which the steward-entity relationship is assigned, the collected information regarding the interactions between the plurality of entities, the collected interaction evaluation parameters, and other factors. The at least one program may be further adapted to prepare one or more relationship reports based at least in part on the one or more relationship maps and to transmit the relationship report to at least one user.

The reporting system of the present disclosure may also be in communication with the server system. The reporting system may be adapted to receive the one or more relationship reports from the server system for presentation to the at least one user. The reporting system may include printers, monitors, and other forms of communicating information to a user.

### BRIEF DESCRIPTION 0F THE DRAWINGS

FIG. 1 is a representation of prior art organizational charts used to manage relationships.

FIG. 2 is a schematic representation of a partial relationship map according to the present disclosure.

FIG. 3 is a schematic representation of a partial relationship map according to the present disclosure showing illustrative relationships that may be formed between two organizational entities.

FIG. 4 is a schematic representation of a method of managing relationships according to the present disclosure.

FIG. 5 is another schematic representation of a method of managing relationships according to the present disclosure.

FIG. 6 is another schematic representation of a method according to the present disclosure.

FIG. 7 is another schematic representation of a method according to the present disclosure.

FIG. 8 is a schematic representation of a relationship management system according to the present disclosure.

FIG. 9 is another schematic representation of a relationship management system according to the present disclosure.

### DETAILED DESCRIPTION

The present description is directed to systems and methods of managing relationships, particularly those relationships important to a corporation or other organization. In various exemplary embodiments and illustrative implementations of the methods, the systems and methods include computerized implementations of relationship maps. A relationship map is a multi-dimensional representation of important connections and relationships between people or entities associated with an organization. Relationship maps can illustrate who is connected to whom and for what purpose, and, in some embodiments, can present information about the relationship and its value to the organization, historically, prospectively, or both.

As discussed above, organizational boundaries are blurring due to a number of factors. It is increasingly more difficult to delineate where an organization begins and where it ends. In some aspects of the systems and methods of the present disclosure, the traditional boundaries of organizations are not restrictive or limiting on the relationship maps. Entities or individuals are included on the relationship maps if they are important to the organization, regardless of whether they are “part” of the organization. If the individual, entity, and/or relationship creates value for the organization, it may be included on the relationship maps of the present disclosure. For example, employees, directors, customers, vendors, investors, members of the community, and even values of the organization, such as environmental responsibility, can be represented on the relationship maps of the present disclosure. Various embodiments or implementations of the systems and methods of the present disclosure may include greater or lesser detail and/or breadth in the relationship selected to be represented on the relationship maps.

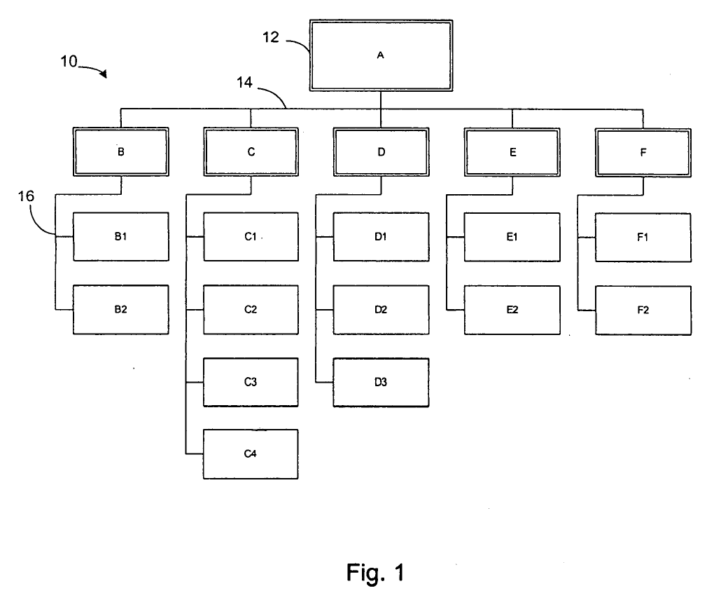

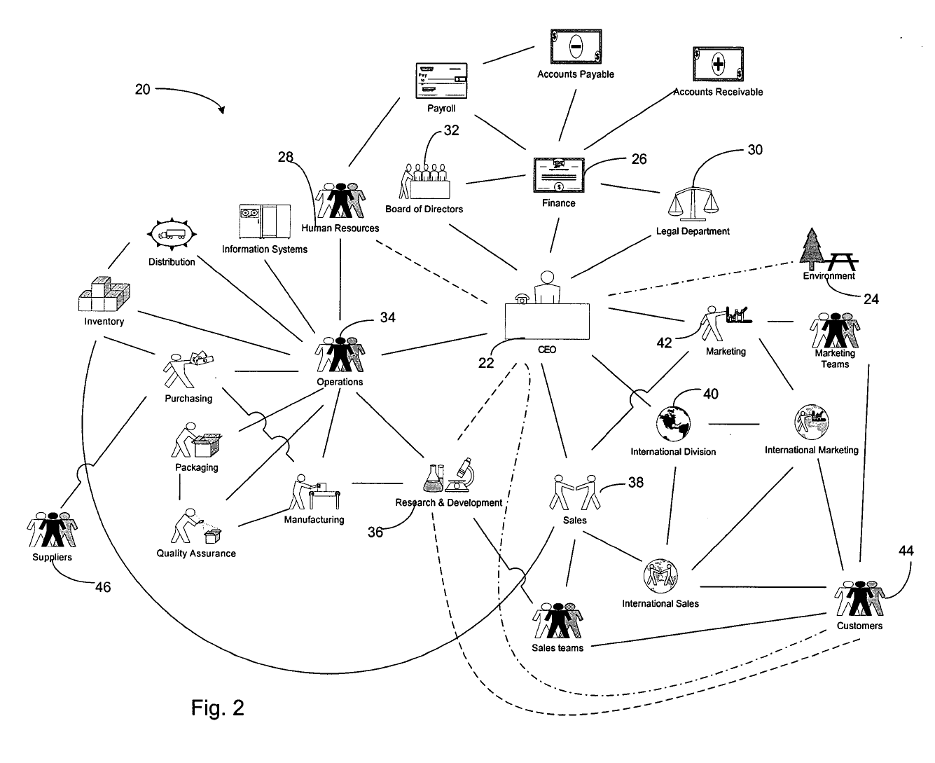

A partial view of an example of a relationship map 20 according to the present disclosure is illustrated in FIG. 2. As compared to the hierarchical, pyramidal structure of the organization chart 10 illustrated in FIG. 1, the relationship map 20 of FIG. 2 is a network or web-like structure with connections between and among the various entities represented on the relationship map. Relationship maps 20 according to the present disclosure are adapted to illustrate all, or a least a substantial portion, of the relationships that are important for an organization or for an individual. For example, a relationship map can be prepared for a corporation, a partnership, a joint venture, a sole proprietorship, or an individual.

As discussed above, FIG. 2 illustrates a partial view of a relationship map 20 showing only a portion of the relationships with the hypothetical organization of FIG. 2. It is within the scope of the present disclosure, that each of the entities represented in FIG. 2 have more relationships among themselves and with entities not represented in FIG. 2. Due to the incomplete representation shown in FIG. 2, it may appear that the CEO 22 is the center of the map or that the map is prepared from the perspective of the CEO. However, it is within the scope of the present disclosure that the map may include the same or substantially the same level of detail for each entity or individual within the organization or network of relationships. In such configurations, the center of the map may be more difficult to identify. Due to the potentially infinite interconnectedness of the individuals and organizations, relationship maps according to the present disclosure may, in some aspects of the present disclosure, be considered complete when substantially all of the important relationships related to an organization or an individual have been included and mapped.

Complete relationship maps include substantially all important relationships necessarily requires a subjective determination of which relationships are important for a given user and for a given map utility. Accordingly, a complete relationship map for a beginning sales person in an organization may appear substantially different than a complete relationship map for the CEO or president of the same organization, as will be discussed in greater detail herein. With reference to FIG. 2, it can be seen that the partial view of relationship map 20 may be considered to be a complete relationship map that has been “zoomed in,” “drilled down,” or otherwise specially prepared to illustrate the relationship map from the perspective of the CEO, illustrating primarily the relationships that are important for the person in the CEO's position. Similarly, the focus may shift to the vice president of operations or the vice president of sales or any other individual or sub-organization within the company.

Relationship maps according to the present disclosure may be used to represent, illustrate, analyze, and/or monitor relationships between any two or more entities. For example, relationship maps similar to relationship map 20 of FIG. 2 may be prepared for individuals, partnerships, teams, companies, or any size of organization provided that there are at least two people to form a relationship. It is within the scope of the present disclosure that relationship maps 20 may be more particularly suited for application with individuals or entities that are managing a plurality of relationships to maximize a return or a value to the individual or entity. For example, a company may seek to manage a plurality of relationships to maximize profits. An individual may find relationship maps 20 valuable to balance the many responsibilities and relationships in his/her life, such as work, family time, personal recreation time, personal finance time, hobbies, community involvement activity, and the like.

As used herein, the term entity is used broadly to refer to individuals, sole proprietorships, partnerships, teams, joint ventures, companies, corporations, organizations, or any other collection of individuals. Additionally, entity may be used to refer to values of the organization, inanimate objects, or functions within the organization. In FIG. 2 for example, the Environment 24, which may be considered a value or an inanimate object, is included as an entity with which the CEO has a relationship. Similarly, functions such as Finance 26, Human Resources 28, and the like are represented as entities on relationship map 20. Additionally, though not included in FIG. 2, assets such as real property, equipment, and the like may be represented on relationship maps according to the present disclosure to illustrate a particular entity's responsibility for or relationship with those assets, which may also be considered entities. As used in FIG. 2, the illustrated entities may be considered to represent functions, values, departments, and/or one or more individuals within departments.

Returning to the exemplary relationship map illustrated in FIG. 2, CEO 22 is illustrated has having relationships with a number of entities, including Environment 24, Finance 26, Human resources, 28, Legal Department 30, Board of Directors 32, Operations 34, Research and Development 36, Sales 38, International Division 40, Marketing 42, Customers 44, and Suppliers 46, each of which have at least one relationship with other entities on relationship map 20. As can be seen in FIG. 2, relationship map 20 is much more interconnected and networked than traditional organizational charts and is more representative of the relationships that need to form in successful modern organizations. As discussed above, relationship map 20 is a partial view only and several relationships between entities have been omitted for clarity, such as relationship between Legal Department 30 and Human Resources 28 among others.

With continued reference to FIG. 2, it can be seen that some of the CEO's relationships are represented with differently styled lines, including solid lines, dashed lines, and dash-dot lines. The different line styles illustrated may represent different types of relationships the CEO has with these entities. For example, the solid lines may represent primary relationships, the dashed lines may represent secondary relationships, and the dash-dot lines may represent tertiary relationships. Additional line styles may represent still other types of relationships.

While relationship map 20 illustrates more primary relationships than secondary or tertiary relationships for the CEO, the opposite may also be true. For example, primary relationships may include a limited number of relationships while additional relationship types may include increasingly greater numbers of relationships, as will be discussed below. Whether a particular relationship is categorized as primary, secondary, tertiary, or otherwise may depend on one or more of a number of factors such as value to the organization, value to the CEO, time commitment required by the relationship, or other needs of the relationship. Additionally, due to the comprehensive nature of relationship maps 20 according to the present disclosure, the relationship of the CEO to a particular entity need not determine that entities relationship with all other entities. For example, Research and Development 36 is indicated as a secondary relationship for CEO 22 in the exemplary relationship map of FIG. 2. However, Research and Development 36 is also indicated as a primary relationship for Operations 34. In this manner, Research and Development 36 has at least two ways of communicating and collaborating with the CEO and the CEO has at least two ways of supervising and communicating with Research and Development 36.

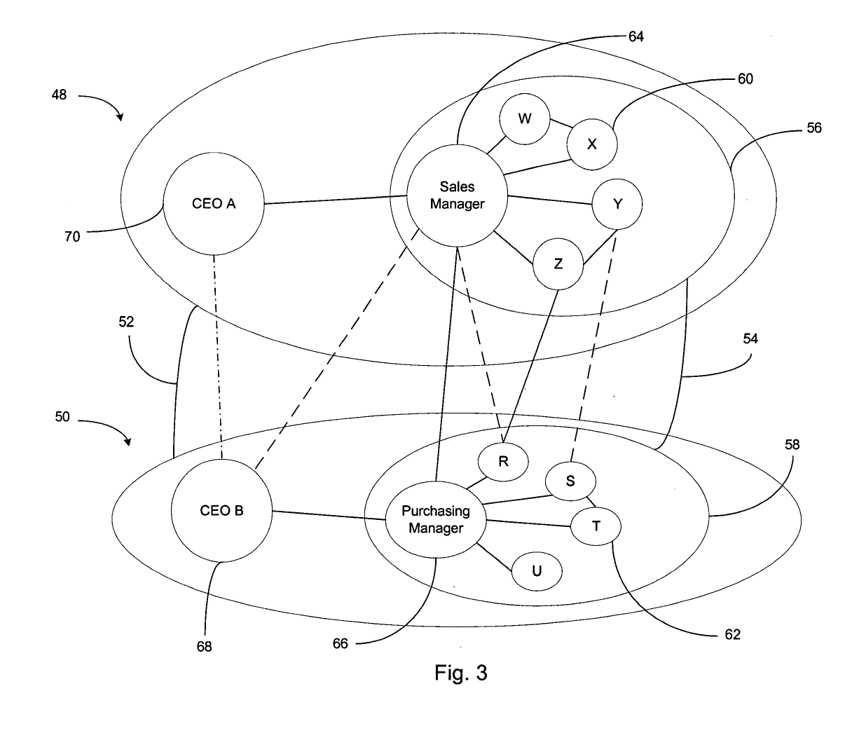

With continued reference to FIG. 2, it is within the scope of the present disclosure that relationship maps 20 include entities that are internal to a given organization and entities that are external to an organization. This is illustrated in FIG. 2 by entities such as Customers 44 and Suppliers 46. FIG. 3 presents a partial view of a relationship map within the scope of the present disclosure. FIG. 3 may be considered to be a further “zoomed in” view of the complete relationship map 20 discussed above, focusing on the relationships between Organization A, designated with reference numeral 48, and Organization B, designated with reference numeral 50. Continuing with the exemplary relationship map of FIG. 2, Organization A 48 may be the principal organization of FIG. 2 while Organization B 50 may be a Customer 44 of Organization A.

As can be seen in FIG. 3, Organization A 48 has an organizational relationship 52 with Organization B 50. While such a representation may be sufficient for some relationship maps within the scope of the present disclosure, in other maps it may be desirable to see greater detail about this relationship. For example, a more detailed relationship map 20 would illustrate a seller-buyer relationship 54 between the Sales Department 56 of Organization A and the Purchasing Department 58 of Organization B. And on relationship maps 20 with progressively greater levels of detail, relationships between actual individuals in the organizations may be represented, such as primary relationships between one or more Sales Persons (W, X, Y, and/or Z) 60 and one or more Purchasing Agents (R, S, T, and/or U) 62. Similarly, there may be secondary or other relationships between Sales Persons 60 and Purchasing Agents 62. Furthermore, depending on the nature of the relationship between the organizations, Sales Manager 64 may have a relationship with Purchasing Manager 66, which relationship may be a primary, secondary, or other type of relationship. In other types of relationships between the organizations, Sales Manger 64 may have relationships with Purchasing Agents 62 or directly with CEO B 68. Additionally, in some relationships CEO A 70 of Organization A may wish to have a more direct relationship with Organization B in addition to the communication and information he receives via his relationship with Sales Manager 64. Accordingly, CEO A 70 may have a relationship with one or more individuals at Organization B 50, such as relationship with CEO B 68. It is within the scope of the present disclosure that the relationship between the CEO's may be any type of relationship, including a tertiary relationship as illustrated in FIG. 3.

Relationship maps 20 illustrated in FIGS. 2 and 3 are two-dimensional representations of the relationships within or related to an organization. Relationship maps 20 within the scope of the present disclosure may also be multi-dimensional. In an exemplary multi-dimensional map, all primary relationships may be illustrated as being on a first tier, secondary relationships on a second tier, and so forth. Depending on the connections and interconnections between entities displayed in the relationship map, the complexity of the multi-dimensional representation may become increasingly difficult to illustrate for an entire organization. In some examples of multi-dimensional relationship maps according to the present disclosure, the multi-dimensional maps may be limited to the relationships of a particular entity in the organization, such as the relationships of the CEO, showing the type and degree of interconnectedness of those with whom the particular entity has a relationship and the nature of that relationship.

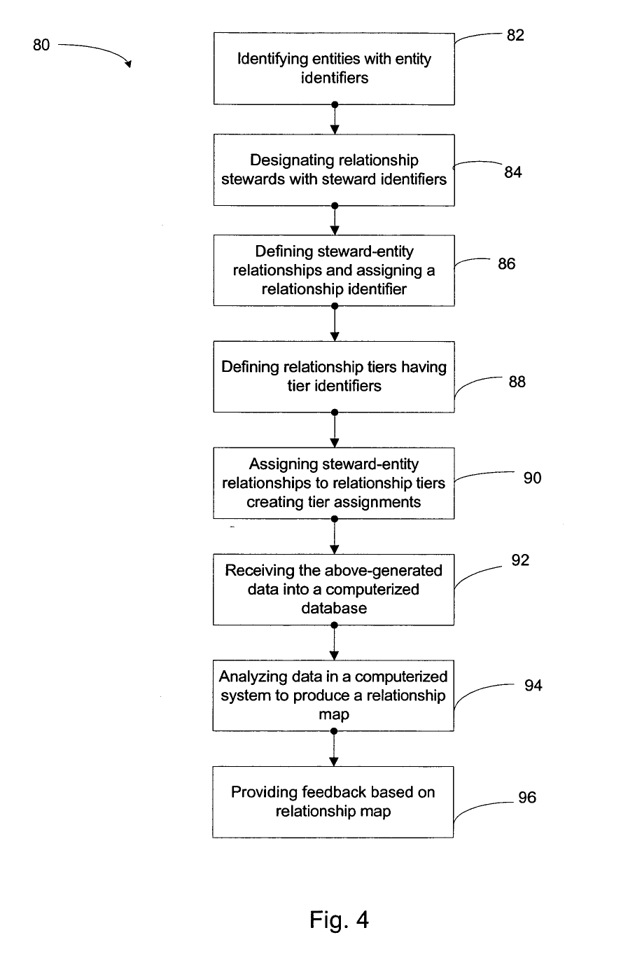

With reference to FIGS. 2 and 3, it can be seen that any efforts to identify, analyze, and report on all the relationships in and related to an organization can become increasingly complicated as the size of the organization increases. However, relationship management according to the present disclosure is facilitated by a computerized method, illustrations of which are shown in FIGS. 4-6, and/or by computerized systems, illustrations of which are shown in FIGS. 9 and 10.

As can be seen in FIG. 4, a computerized method 80 of managing relationships according to the present disclosure may begin, at 82, by identifying a plurality of entities. Each entity may be assigned an entity identifier for use in the computerized methods. The entities identified may include individuals, teams, companies, or other entities such as described above. The entities identified may include personnel within the organization and/or may include people with whom the organization has a relationship but that are not part of the organization. Additionally, the entities identified at 82 may be limited to entities of particular importance to the person or entity doing the identifying. For example, a CEO may identify a different set of entities than a sales manager would identify. In some aspects of the present disclosure, the identified entities may be limited to those entities identified by a select group of individuals. In other aspects, the opportunity to identify entities for inclusion in the computerized method may be open to a substantially larger set of individuals.

In a corporation for example, the identified entities at 82 may be identified by a committee of vice-presidents and managers asked to select those external entities that are of greatest value to the corporation. Alternatively, the employees at a company, whether all employees or a subset of the employees, may be asked to identify entities both internal and external that are important to the operation and value of the company. The individuals or groups asked to identify entities at 82 will affect the nature of the relationship map and reports produced by the methods of the present disclosure as discussed herein.

Additionally, computerized methods of managing relationships 80 within the scope of the present disclosure include, at 84, designating one or more of the entities as relationship stewards. Entities that are designated as relationship stewards are assigned steward identifiers for use in the computerized methods herein. As with the entities identified above, which of the entities are designated as relationship stewards may depend on the individual or group of individuals doing the designating. Additionally, the entities designated as relationship stewards may depend on the intended utility of the relationship map and the entities that were identified.

Entities may be designated as relationship stewards for a number of reasons. For example, an entity within an organization may be designated as a relationship steward because of his/her relationship with an external entity and his/her responsibility for the relationship with that external entity. Similarly, an internal entity, such as a sales manager, may be designated as a relationship steward because of his/her relationship with other internal entities, such as sales persons. Additionally, an identified entity may be designated as a relationship steward when some other entity determines that the first entity needs to begin taking on greater responsibility for a particular relationship.

The designation of relationship stewards among the plurality of entities may be performed by any number of people. For example, the human resources department of a corporation may review a list of the employees within the organization and designate one or more of them as relationship stewards. Alternatively, the head of each department may identify relationship stewards within each department. In other examples, one or more of the entities may be given the opportunity to designate themselves or others as relationship stewards. It is within the scope of the present disclosure that many of the entities are also designated as relationship stewards. Additionally, it is within the scope of the present disclosure that substantially all of the entities are also relationship stewards. Alternatively or additionally, it is within the scope of the present disclosure that all of the internal entities within a particular organization are designated as relationship stewards.

As suggested by the foregoing, relationship stewards designated at 84 are stewards over one or more relationships. More specifically, steward-entity relationships are defined at 86 and each relationship is assigned a relationship identifier for use in the computerized methods of the present disclosure. Similar to the discussions above related to the identification of entities at 82 and the designation of relationship stewards at 84, defining steward-entity relationships at 86 may be performed by any number of individuals or groups of individuals. In some aspects of the present disclosure, the relationship stewards may be identified and each steward may be allowed to identify one or more entities with whom the steward has a relationship, thereby defining at least one steward-entity relationship corresponding to each relationship steward. In other implementations, another entity or user of the method, such as a member of management or a third-party consultant or auditor, may define the steward-entity relationships assigning each relationship to a corresponding relationship steward.

While defining steward-entity relationships is illustrated graphically at 86 following the designation of relationship stewards at 84, it is within the scope of the present disclosure that the steward-entity relationships may be defined or identified prior to or as part of designating the relationship stewards. For example, upon identifying the relevant entities at 82, one or more of the entities or another user may define relationships, either actual, existing relationships or preferred, hypothetical relationships, among those entities. The relationship steward may be designated from the members of the defined relationships. While the procedures of the present methods may be completed in any order, their order of operation may depend on who is performing each procedure. For example, if the relationship stewards are asked to define their corresponding steward-entity relationships, the relationship stewards will be designated prior to defining the steward-entity relationships. Similarly, the other elements of the present methods 80 discussed in connection with FIGS. 4-7 may occur in any order practicable.

With continuing reference to FIG. 4, the computerized methods of the present disclosure may also include, at 88, defining two or more relationship tiers and assigning each tier a tier identifier. It is within the scope of the present disclosure that any number of tiers may be defined. As described herein, the steward-entity relationships defined above are, through the methods of the present disclosure, assigned to relationship tiers by the users. Accordingly, any number of tiers may be created according to user preferences.

In some implementations of the present methods, three relationship tiers are defined and each of the steward-entity relationships are assigned to one of the three relationship tiers. In other implementations of the present methods, the individuals or entities responsible for assigning the relationships to tiers may determine a number of tiers based on their preferences. For example, in some implementations, the department managers may be responsible for assigning steward-entity relationships to relationship tiers. In such implementations, one department manager may prefer three tiers while the manager of another department may prefer five tiers. Additionally or alternatively, individual relationship stewards may be responsible for assigning their corresponding steward-entity relationships to relationship tiers. In such implementations, each relationship steward may define as many relationship tiers as he/she believes necessary for effective management of the corresponding steward-entity relationships.

Defining two or more relationship tiers, at 88, includes assigning a tier identifier to each tier for use in the computerized methods and systems of the present disclosure. Additionally, each of the relationship tiers may be defined to include relationship objectives. The nature of the relationship objectives may be determined by the individuals or entities defining the relationship tiers (described above) or may be determined by another user, such as a third-party consultant, a relationship auditor, or a member of management not associated with the definition of the tiers. While relationship objectives may be consistent for a given tier across an entire organization, relationship objectives may also be customizable for each relationship steward. For example, tier one objectives for a project manager relationship steward may be different from tier one objectives for a departmental manager relationship steward. Such customization may be performed by those defining the relationship tiers, by those establishing the relationship objectives for the organization, or on a case-by-case basis for relationship stewards. In some implementations of the present method, the relationship objectives may include one or more factors, some of which may be measurable internally and some of which may only be measurable through reference to external entities, such as surveying the external entity for feedback.

An exemplary, though not exhaustive, list of factors that may be included in the relationship objectives of one or more relationship tiers includes the interaction frequency, such as the number of times the relationship steward and the entity will interact over a given time period, the interaction duration, such as the average amount of time the steward spends with the entity in each interaction, the interaction quality, such as a measurable and monitorable representation of the quality of the interaction, and other business statistics associated with the steward-entity relationship, such as the dollar value of transaction, the number of transactions, the types of transactions, and the types or details about products or services provided or consumed. The relationship objectives may include any number of factors that are selected to help the relationship steward and/or the organization manage the relationships. The relationship objectives may be influenced by the type of steward-entity relationship. For example, a relationship between a sales person and a purchasing agent may include relationship objectives related to dollar values of the transaction. Similarly, a human resources manager's relationship with employees may not include such an objective but may include objectives such as interaction frequency.

The quality of the interactions in a relationship may be a more difficult factor to measure and record over time compared to easily quantifiable data such as interaction frequency or average interaction duration. In some implementations of the present methods and systems, the relationship steward of a steward-entity relationship may measure the interaction quality of each interaction. This may facilitate the collection of the data but may not reflect the desired measurement, which may be the quality of the relationship from the entity side of the relationship. A measurement of interaction quality from the perspective of the entity may be obtained by surveying the entity on the entity side of the relationship. In some implementations, this survey may be periodic such as weekly, monthly, quarterly, etc. Additionally or alternatively, the survey of the entity's perspective of the interaction quality may occur at substantially the same time as the interaction, such as at the end of each interaction. A number of survey techniques may be implemented to collect interaction quality data, such as web-based surveys, email surveys, phone surveys, mail surveys, or personal surveys.

While a descriptive representation of the interaction quality is helpful, interaction quality may also be measured via an alphanumeric representation, which may be akin to a traditional report card system. For example, an interaction deemed to be high quality or positive may be given an “A,” while a negative interaction may be given an “F.” Additionally or alternatively, and to facilitate calculations and monitoring of the interaction quality over time, the survey results may produce a numeric entry, such as 1, 0, or −1. In some implementations, the survey, whether of the entity or the relationship steward, may request a numeric entry. In other implementations, the survey may accept an alphanumeric entry (a combination of letters, numbers, and/or symbols) and convert, either automatically through computerized means or manually through user intervention, the alphanumeric entry into a numeric entry system for facilitated measuring and monitoring over time.

In some implementations of the present system, users may consider relationships and the health of those relationships in terms of a trust account wherein positive interactions add to the trust account and wherein negative interactions deduct from the trust account. In such implementations, the interaction quality measurement may be a positive number for positive interactions and a negative number for negative interactions. Accordingly, interaction quality indicators can be measured over time and summed to produce a measurement of current relationship trust account balance.

As indicated herein, interaction quality may be measured from the perspective of the relationship steward or from the perspective of the entity in a given steward-entity relationship. Data may be collected from either one or both of these perspectives regarding the interaction quality. When interaction quality data is collected from the entity perspective, the entity may be prompted to enter data in a particular format, such as positive or negative numbers within a particular scale, or the entity may be allowed to enter text descriptive of their perspective. In implementations where the entity perspective is collected in a format that is not conveniently monitored over time in a computerized system, the entity's perspective may be reviewed by another individual or group of individuals to convert it into a format that is used by the organization.

When interaction quality data is collected from both sides of a steward-entity relationship, a user of the current methods and systems may monitor the progress or status of the relationship from both perspectives. In such configurations, relationship stewards can receive reports that illustrate the potentially differing perspectives and can seek to improve the quality of the interactions. Additionally, they can use the differences in perspective to seek to understand the relationship better and how to improve the entity's perception of the goods, services, or other interactions received from the relationship steward.

Additionally, the defined relationship tiers may be defined to accommodate a maximum number of steward-entity relationships for each relationship steward. For example, a first tier may be defined to accommodate the fewest number of relationships, while a second tier may accommodate a greater number of relationships, and, optionally, one or more additional tiers may be defined to accommodate progressively greater numbers of steward-entity relationships. The number of steward-entity relationships accommodated in a given relationship tier for a given relationship steward may depend at least in part on the ability of the relationship steward to manage relationships. Additionally and or alternatively, the accommodation limits of the relationship tiers may be established organization wide. As described above, the relationship tiers may be defined in a number of manners, and the accommodation limits may be established in similar manners.

As described above, the relationship tiers each may have different relationship objectives, or objectives that have at least one element that is different from the others. Accordingly, steward-entity relationships that require the greatest amount of care and attention may be placed in the first tier accommodating the fewest number of relationships. Similarly, those relationships that require somewhat less attention but are still very important to the relationship steward and/or the organization may be placed in a second tier. Additional relationships may be placed in appropriate tiers depending on their importance to the company, their importance to the relationship steward, their relative attention requirements, or other factors.

In some implementations of the present methods, the combination of the first three relationship tiers may collectively accommodate from about 100 steward-entity relationships to about 250 steward-entity relationships. Additional tiers may accommodate a larger number of steward-entity relationships. In some implementations, the first tier may accommodate between about 10 relationships and about 25 relationships, the second tier may accommodate between about 20 relationships and about 75 relationships, and the third tier may accommodate between about 70 relationships and about 150 relationships. It is within the scope of the present disclosure that each set of relationship tiers, whether defined by relationship stewards, by management, or by a third-party such as a consultant, may accommodate different numbers of relationships according to the needs and abilities of the relationship stewards. While the successive relationship tiers may accommodate progressively greater numbers of relationships in some implementations, it is also within the scope of the present disclosure that the tiers for a particular steward or for the organization as a whole accommodate the same number of relationships and are distinguished only by the relationship objectives.

As suggested by the above discussion, the methods of the present disclosure include, at 90, assigning the various steward-entity relationships to a relationship tier, such as a first tier, a second tier, or another tier. Accordingly, the steward-entity relationships are given tier assignments that may be used by the computerized systems and methods of the present disclosure. For example, a given steward-entity relationship may be identified as a first tier relationship, a second tier relationship, etc. The assignment of particular steward-entity relationships to relationship tiers may be performed by any number of individuals or groups of individuals. For example, the assignments may be made by the corresponding relationship stewards; by the relationship stewards in cooperation with another individual such as a manager, an outside consultant, or the entity of the relationship; by a manager in the organization; by a board of advisors within or outside the organization; or by another individual or groups of individuals. The party making the assignments may be determined by the purpose for which the method and resulting organizational maps and reports will be used.

While the present methods assign steward-entity relationships to relationship tiers, individual entities are not assigned to a particular tier. For example, a particular client company is not assigned to the first tier, but a particular sales person's relationship with the particular client company may be assigned to the first tier (or any other tier). Accordingly, a given entity may be on the entity side of numerous steward-entity relationships, each relationship being with a different relationship steward. For example, an employee may be on his supervisor's first tier and may be on the human resources manager's second or third tier. It is also within the scope of the present disclosure that a given individual may be on the entity side of multiple steward-entity relationships with the same relationship steward, such as when the individual has multiple roles or functions in an organization. In such situations, the single individual (or team or group of individuals) actually is represented in the present system and methods as more than one entity, such as “Bob, sales manager” and “Bob, sales person for region/product XXX.”

Similarly, a given individual, team, or other entity may be both a relationship steward and an entity within the scope of the present disclosure. Continuing with the previous example, while the employee's supervisor may be a relationship steward in that relationship, the supervisor may be an entity in his own relationship with his departmental manager or other individual. It is also within the scope of the present disclosure that a particular entity may be a relationship steward in a relationship with another entity and may also be on the entity side of a relationship defined by that entity. In other words, in implementations where the relationship stewards are self-selected or otherwise selected and then allowed to define steward-entity relationships, two relationship stewards may identify relationships with each other, each identifying themselves as the steward and the other as the entity. Such a situation results in two identifiable relationships, each separately assignable to different or the same relationship tiers. An example of this situation may arise such as when an employee considers himself responsible for his own relationship with his manager and the manager considers himself responsible for the relationship he has with his employees.

As illustrated in FIG. 4, the methods of managing relationships within the scope of the present disclosure further include, at 92, receiving the data generated through the above steps into a computerized database or system of databases. As used herein, database may be used in the singular or plural to indicate one or more databases operatively coupled through communication channels and appropriate programming to cooperatively store, access, manage, manipulate, and retrieve data stored therein. More specifically, the methods include receiving the entity identifiers, the steward identifiers, the relationship identifiers, the tier identifiers, and the relationship tier assignments into a computerized database. It is within the scope of the present disclosure, that the database further receives additional information such as contact information for the entities, transaction history for the entities, relationship objectives for the different relationship tiers, and other data suggested herein.

Additionally, the computerized databases may receive data from other external sources. In one implementation, the database may be preprogrammed or user-programmable with certain criteria that may be used as a basis for evaluating the other inputs prior to entry into the database. Additionally or alternatively, the database may receive data from external existing sources within the organization. For example, the databases may receive data from contact managers, email managers, integrated personal information managers (such as Microsoft Outlook, Lotus Notes, etc.), call center managers, order placement or fulfillment programs, or other programs that may be used in an organization. The databases of the present disclosure may be adapted to synch automatically or manually with the external programs. Such cooperation with external sources may reduce the redundancy of internal systems to reduce the number of times data needs to be entered and to facilitate the maintenance of accurate information across several programs and systems.

With continuing reference to FIG. 4, some or all of the information and data received by the database system may be analyzed to produce a relationship map, at 94. In some implementations, the entity identifiers, the steward identifiers, the relationship identifiers, the tier identifiers, and the relationship tier assignments are analyzed to produce a basic relationship map. Additionally or alternatively, it is within the scope of the present disclosure that some or all of the additional information may be analyzed to produce a more detailed relationship map. While FIGS. 2 and 3 illustrated a simplified and partial view of a relationship map, the complete relationship map produced by the computerized methods of the present disclosure may be more complicated than can be represented on paper. Accordingly, the relationship maps of the present disclosure may reside in the computerized system as a series of related and interrelated data.

In some implementations of the present methods, the relationship maps may be stored in the computerized system in a relational database, such as databases used in Microsoft Access, SQL databases, Oracle databases, or other relational databases. In such implementations, one or more tables may store some or all of the data used to produce the relationship map. The data in the one or more tables may be linked together so that the tables are related and data from more than one table can be accessed to produce relationship maps and reports. As described herein, the data in these relational databases may be stored, accessed, modified, manipulated, reported, and otherwise exploited in any number of manners to produce one or more relationship maps according to the present disclosure.

Continuing with FIG. 4, the methods of the present disclosure further include, at 96, providing feedback based at least in part on the relationship map. The feedback may be provided to any number of individuals or entities, including relationship stewards, managers or supervisors of the organization, auditors such as third-party consultants or internal relationship managers, or another entity. The feedback provided may be presented in numerous ways, including via graphical representations on a computer monitor or on paper or via tabular or textual descriptions. For example, the computerized system may be adapted to present a user interface allowing a user to select a desired level of detail and a desired perspective. The system may then present a graphical representation or a textual report of the relevant relationships based on the user input. The graphical representation or textual report may be presented either on a computer display or on a computerized printout.

In some implementations of the present method, the computerized system may be adapted to present the feedback via graphical representations on the computer display in two or three dimensions. Additionally or alternatively, the graphical representations on the computer display may be interactive such that the initial feedback screen is a high-level view of an entire organization or a subset of an organization. The user may then interact with the computer display and the computer system to select regions of the graphical representation for increased detail. In some implementations, the computerized graphical representation may be akin to a relationship map, such as shown in FIG. 2, wherein the user can effectively zoom in on regions or portions of the map for increased detail, similar to zooming in on traditional geographical maps.

Additionally or alternatively, the computer-generated graphical representation may include color-coding or other symbolism to indicate to the user areas, of the relationship map provided as feedback, that should be of particular concern to the user. For example, relationships that are not meeting their relationship objectives may be indicated in a different color, be identified with a flag, or otherwise indicate to the user the need to focus more on that relationship. Other mechanisms and systems may be used to alert users to potentially problematic relationships. For example, the feedback provided may additionally or alternatively include warning systems such as automatic emails, instant messages, text messages, or other forms of communication to alert one or more users of a relationship needing attention.

The communication may also be in the form of a report on the relationships, such as a periodically generated log or a user-generated report. In some implementations, the report or log may include tables, charts, and/or narrative text to communicate the feedback. Such communications whether warning of specific relationships or reporting on multiple relationships may have predefined criteria for determining which relationships to highlight as needing attention. The criteria may include any number of factors depending on the data included in the computerized database and may include such factors as not meeting one or more relationship objectives. In some implementations, the feedback provided, whether via graphical representation or a textual or tabular report, may highlight relationship stewards that are overextended or entities that are not sufficiently connected or that have not been given a sufficiently high priority within the organization. In implementations where feedback is received regarding interaction quality, the criteria for highlighting or warning about a particular relationship may include having a certain number of consecutive negative interactions or having a relationship trust account below a certain threshold.

It is within the scope of the present disclosure that other factors or criteria may be used in determining which relationships in the relationship map need to be reported and/or brought to a user's attention. For example, the methods of the present disclosure include allowing a user to input criteria for development of customized reports. Accordingly, it is also within the scope of the present disclosure that multiple reports may be generated according to the present methods with each report communicating different types of information about the various relationships. The computerized methods of the present disclosure may be adapted to allow a user to customize the feedback received by varying the method of presentation (i.e., on screen, printouts, or both), by varying the level of detail included in the feedback, by varying the relationships presented in the feedback, etc.

It is within the scope of the present disclosure that the methods described herein, including the individual component parts, may be performed or completed by any number of people. More specifically, the organization or entity implementing the methods and systems of the present disclosure may identify a particular utility for the relationship maps and reports of the present disclosure and configure the present methods accordingly by having different individuals performing the process steps. In some implementations, the computerized methods may be adapted to allow an organization to perform the method in more than one configuration to provide a number of perspectives on the relationships of the organization.

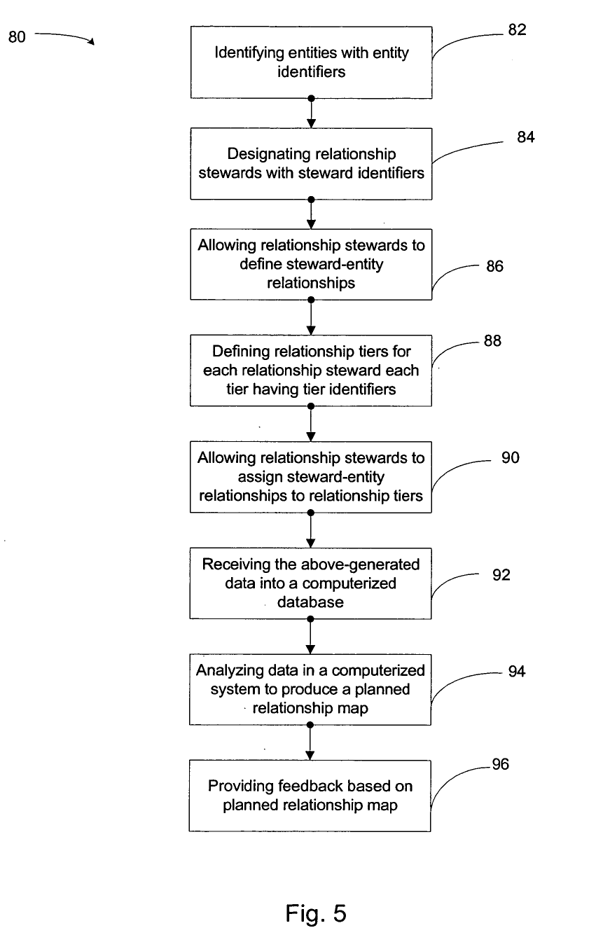

One example of such a configuration is described in FIG. 5, where the implementing organization allows the relationship stewards to perform many of the steps in the method to produce a planned relationship map. With reference to FIG. 5, a method of managing relationships 80 according to the present disclosure is illustrated schematically with like reference numerals referring to similar component steps. As described above, any number of individuals associated with the organization may identify a plurality of entities, at 82, for inclusion in the method of managing relationships. Additionally, any number of individuals may be involved in designating, at 84, one or more of the entities as relationship stewards.

At 86, rather than having a member of management or another user define the steward-entity relationships, the respective relationship stewards may be allowed to define their own corresponding steward-entity relationships. Allowing each relationship steward to define their own corresponding steward-entity relationships may promote a greater sense of responsibility and accountability among the relationship stewards. Additionally, the exercise of identifying those relationships that are important to the relationship steward will help him/her account and recognize the important relationships that need some level of attention.

The relationship tiers, accommodations, and relationship objectives may be defined as described above. That is, the relationship stewards may be involved in defining the relationship tiers and associated objectives and accommodations. Additionally, other users, such as management, consultants, or other individuals associated with the organization may be involved in defining the relationship tiers and associated tier objectives and accommodations. As described above, the number and/or characteristics of the relationship tiers may be customized for each relationship steward or may be uniform for all relationship stewards in the organization.

At 88, the method of producing a planned relationship map to serve as part of the basis for the feedback report may also allow each relationship steward to assign their corresponding steward-entity relationships to the relationship tiers. A relationship steward making these assignments may be presented with the accommodation limits and the relationship objectives of each tier as part of deciding which steward-entity relationships belong in which tier. As discussed above, involving the respective relationship stewards in this process may enhance the feeling of ownership in the relationship and accentuate their responsibility for maintaining that relationship. By categorizing the various relationships into two or more tiers, each relationship steward will be setting goals and targets and recognizing the value of each relationship in the performance of his duties. Additionally, from a management perspective, allowing the relationship stewards to identify their corresponding steward-entity relationships and to assign them to relationship tiers with associated relationship objectives may be analogized to contracting the relationship steward to a certain level of performance with respect to each entity and may provide a mechanism for evaluating whether the relationship stewards are meeting their own self-selected standards.

With continued reference to FIG. 5, it can be seen that the method may proceed as described above to receive the data, analyze the data, and to provide feedback to a user based at least in part on the planned relationship map. It is within the scope of the present disclosure that the feedback may be reported to at least one individual and possibly to many individuals. As described above, a number of different reports or feedback mechanism may be generated in accordance with the present disclosure.

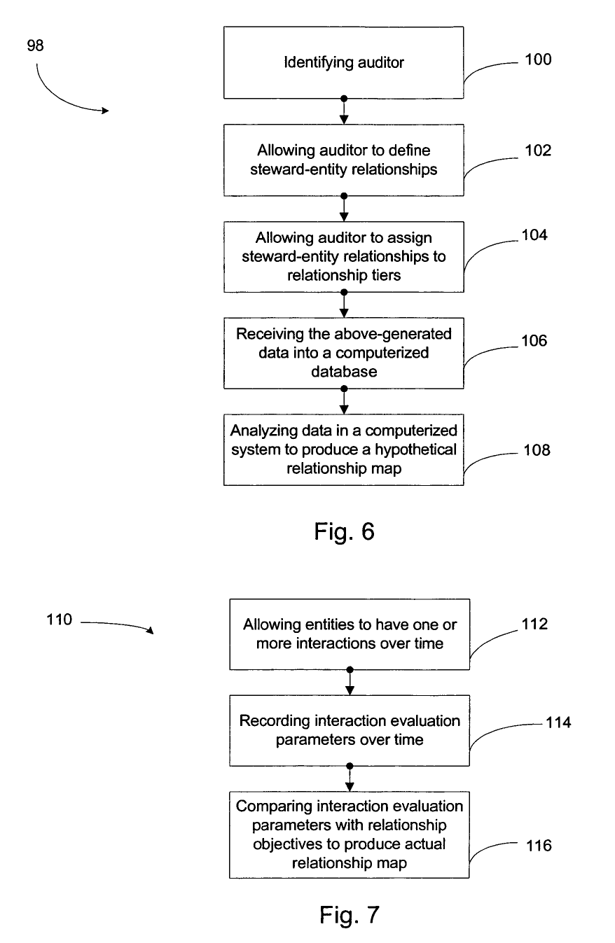

With reference to FIGS. 6 and 7, the present methods may additionally or alternatively be modified to produce other types of relationship maps, such as an actual relationship map or a hypothetical relationship map, and to produce feedback based at least in part on one or more relationship maps. For example, the methods of the present disclosure may include producing planned relationship maps, actual relationship maps, and hypothetical relationship maps and providing feedback based on one or more of the maps, including based on comparisons of two or more of the maps. In such implementations, some aspects of the present methods may need to be repeated and performed in different ways to prepare the desired relationship maps. For example, the planned relationship maps may be produced by allowing the relationship stewards to be involved in the methods as described above. The hypothetical relationship maps may be produced by allowing another user, such as a member of management or another user perform certain aspects of the methods.

Methods of producing hypothetical relationship maps may include one or more of the steps described above, such as identifying entities and relationship stewards. A method of producing hypothetical relationship maps is illustrated in FIG. 6 at 98. As illustrated, such methods include identifying an auditor, at 100. As used herein, auditor refers to any user that is using the methods and systems of the present disclosure to plan, monitor, evaluate, or otherwise observe the relationships in an organization from a managerial or oversight perspective. An auditor may be distinguished from a relationship steward in that a relationship steward using the systems and methods is concerned with his/her own relationships. An auditor in the context of the present disclosure is one using the systems and methods in the interest of the relationships of other entities. Because being an auditor is based on the purpose or objective when using the present systems and methods, it is within the scope of the present disclosure that an individual may be an entity and/or a relationship steward in the methods and systems and also be an auditor. Additionally, multiple auditors may be identified and given access to the present methods and systems to allow any one or more of them to produce the hypothetical relationship maps.

As illustrated in FIG. 6 at 102, the auditor may be allowed to identify one or more hypothetical steward-entity relationships between entities and relationship stewards. Hypothetical steward-entity relationships may be distinguished from planned steward-entity relationships because they are relationships identified by the auditor as ideal or preferred relationships and may or may not be tied with the actual planned relationships identified by the relationship stewards in considering their own relationships and duties. Methods of producing hypothetical relationship maps may also include, at 104, allowing the auditor(s) to assign the hypothetical steward-entity relationships to one of the two or more relationship tiers. Additionally, the data, including the hypothetical data, may be received by a computerized database, at 106, and analyzed by a computerized system to produce a hypothetical relationship map, at 108, from which feedback may be produced as described above.

Hypothetical steward-entity relationships and hypothetical relationship tier assignments may be a planning tool for management and/or may be used for viewing a relationship map in alternative configurations in efforts to identify preferred or ideal arrangements of personnel, assets, time, or other resources. While not illustrated in FIG. 6, methods of producing hypothetical relationship maps may also include allowing auditors to perform additional steps, such as defining hypothetical relationship tiers, to further assist in the planning of the relationships and resources for the organization. Alternatively, the remaining aspects of the present methods may be performed in accordance with any of the procedures described herein. As discussed herein and as with the production of any of the other relationship maps described herein, the methods of the present disclosure may be repeated in whole or in part any number of times to produce variations on the same relationship maps, such as multiple, different hypothetical relationship maps, or to produce a variety of different relationship maps as described herein.

As discussed briefly above, the methods and systems of the present disclosure may also include producing an actual relationship map. Aspects of a method of producing an actual relationship map are illustrated in FIG. 7 at 110. In methods of producing actual relationships maps, some or all of the steps described above may be implemented to define entities, stewards, relationships, and the like. Additionally, the entities may be allowed to have at least one interaction over time, illustrated at 112 in FIG. 7. For example, entities, including relationship stewards and entities, may interact over time as part of their ongoing relationship. Additionally or alternatively, new entities may be identified over time as the organization makes new contacts, hires new employees, or develops new customers.

With continued reference to FIG. 7, interaction evaluation parameters may be recorded over time for at least some of the interactions, at 114. Interaction evaluation parameters may be recorded for interactions within existing steward-entity relationships and for interactions between entities that are not part of a defined relationship. For the purposes of the present disclosure, interaction evaluation parameters may include one or more pieces or types of data about the interaction. For example, interaction evaluation parameters may include data corresponding to the relationship objectives of the relationship tiers. The actual interaction evaluation parameters may be compared, at 116, with the relationship objectives to automatically assign the relationships to the appropriate relationship tier thereby producing an actual relationship map. As described above, measuring the quality of each interaction may be done from a variety of perspectives and may be recorded in various manners. The impact of each interaction on the relationship may be represented by a relationship trust account indicator, such as the numeric or alphanumeric entries described above. Additional interaction evaluation parameters may be recorded such as the dollar value of transactions, the duration of each interaction, the date, time, and/or place of the interaction, etc. The actual relationship map may be used to provide feedback to users in a number of ways as described herein.

It is within the scope of the present disclosure that the methods described above may be implemented alone or in any number of combinations to produce relationship maps and feedback. In some implementations, an organization may wish to perform the method differently at different times to produce feedback with different types of information. For example, but without limitation, an organization may implement a relationship management method within the scope of the present disclosure by preparing a planned relationship map and a hypothetical relationship map according to the descriptions provided herein. The organization may receive feedback based on either of these reports or based on a comparison of the two reports. For example, the auditor may compare its hypothetical steward-entity relationships with the planned steward-entity relationships. Additionally or alternatively, the auditor may compare the hypothetical tier assignments with the planned tier assignments. Similarly, the organization may wish to observe the relationships and priorities on a higher level. With reference to the example of FIG. 3, the organization may wish to confirm that someone at Organization A has a tier one relationship (or other type of relationship) with someone at Organization B. Such reporting and feedback is within the scope of the present disclosure. Additionally or alternatively, the organization may wish to compare actual results and relationships with hypothetical (or planned) relationships, either on a detailed relationship-by-relationship level or on an organizational level.

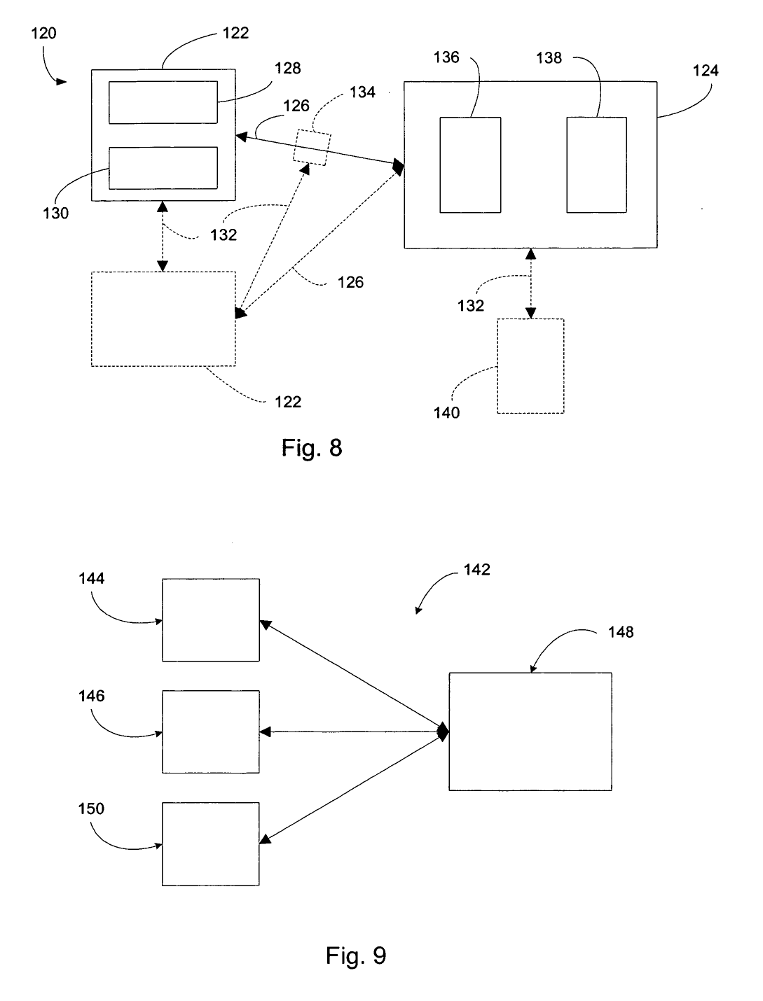

Additionally and as suggested above, it is within the scope of the present disclosure that the present methods be performed in cooperation with a relationship management system or a computer implemented system as described in part above and as described in more detail below. With reference to FIG. 8, a relationship management system 120 for assisting relationship stewards allocate resources among a plurality of steward entity relationships is illustrated schematically. As illustrated, relationship management system 120 may include at least one user interface system 122, at least one server system 124, and a computer network 126 connecting server system 124 and user interface system 122.

The at least one user interface 122 includes a data input apparatus 128 and a data reporting apparatus 130. Data input apparatus 128 may be adapted to allow one or more users, such as entities, relationship stewards, auditors, or other users, to input data regarding at least one steward-entity relationship. Data reporting apparatus 130 may be adapted to display information regarding at least one steward-entity relationship. Consistent with the methods described herein, the data input apparatus may be used to input entity identifiers, relationship tier assignments, interaction evaluation parameters or other such data described above. Similarly consistent with the methods described above, the data reporting apparatus may include printers, computer displays, or interactive computer displays to facilitate the provision of feedback according to the present disclosure.

In some embodiments, data input apparatus 128 and data reporting apparatus 130 may be component parts of a single user interface system, such as a personal computer or a computer workstation. Additionally or alternatively, data input apparatus 128 and data reporting apparatus 130 may be provided on separate apparatus, may be directly coupled together or may be coupled only via the server system. When more than one user interface system 122 is included in relationship management systems 120, each user interface system may be of the same or of different configurations. For example, a first user interface system may be configured for use by relationship stewards in a call center where data input is the primary function, while a second user interface system may be configured for use by relationship stewards in management that may also be serving as auditors and requiring additional reporting capabilities.

User interface systems 122 may include apparatus and systems adapted to electronically communicate with server system 124 over computer network 126. Without being bound by the limitations of existing technology, the present disclosure includes user interface systems 122 such as desktop computers, networked computer workstations, laptop computers, personal digital assistants, cellular phones, order entry and fulfillment systems, and other data input and reporting systems.

The communication of user interface system 122 with server system 124 may be continuous or substantially continuous, such as with a networked computer workstation that has a direct communication link to server system 122. Additionally or alternatively, the communication may be non-continuous such as when laptops, personal digital assistants, or other systems are configured to communicate and synchronize data with the server system only when connected to the computer network.

For example, a laptop or personal digital assistant may be provided with a local version of the software and data to enable remote operation of some aspects of the system, including input of data. The remote laptop may periodically connect to the server system via a number of methods, such as direct network cable connection, connections via the Internet, wireless or otherwise, or through dial-in connections, to upload data, download data, or otherwise synchronize with server system 124.

The diversity of user interface systems 122 that may be used in connection with relationship management systems 120 of the present disclosure may be adapted to receive relationship data from a number of individuals consistent with the methods described above. For example, one or more user interface systems 122 may receive data from at least one user selected from the group consisting of relationship stewards, entities, auditors, and others. The data input via the user interface system may depend on the context of the relationship. For example, it may include contact information for the entities identified. Additionally, for relationships with buyers and sellers, the data input may include data regarding past transactions, business type, etc. For relationships between employees, the data may include information about current projects or teams, salary, work history, etc. It is within the scope of the present disclosure that virtually any type of information may be input via the user interface system, including information about ongoing interactions over time, to enable the relationship management system to produce one or more relationship reports for a user. The above description of the methods of the present disclosure provides additional examples of data that may be useful in producing relationship reports.

With continued reference to FIG. 8, when more than one user interface system 122 is included, the multiple user interface systems 122 may be connected in a number of ways. For example, two or more user interface systems 122 may be coupled together for communication between themselves, such as illustrated with dashed communication connection 132. Additionally or alternatively, the multiple user interface systems may communicate via a hub or router 134 and a plurality of communication connections 132 between hub 134 and user interface systems 122. Similarly, each of the user interface systems may be coupled directly to server system 124 and communicate via the server system. It is within the scope of the present disclosure that computer network 126 may include any number of communications apparatus to enable electronic communication between the various components of relationship management system 120. For example and without being bound by the limitations of existing technology, computer network 126 may include wireless or wired connections and networks and may include transmitters, receivers, hubs, routers, servers, cables, etc. as required by the computer network.

As schematically illustrated in FIG. 8, relationship management system 120 includes one or more server systems 124. Server systems 124 may include at least one program 136 and at least one database 138. Database 138 may be adapted to receive data from at least the user interface systems 122 and may be adapted to store data including the data input by one or more users via the user interface systems. As described above in connection with the methods of the present disclosure, one or more computerized databases may be used. In some embodiments, a relational database may be implemented with one or more tables of related information. Also, server system 124 of the present disclosure may be in communication with additional databases or information sources, such as email systems, ordering systems, or other business systems that may contain or receive relevant data. As described herein, the communication between the present relationship management systems and other business systems may be continuous, substantially continuous, periodic in accordance with a synchronization schedule, or upon user intervention to initiate synchronization.

As described above, server systems 124 may include at least one program 136. Programs 136 may include software routines or embedded routines for receiving, storing, accessing, and otherwise manipulating the data within and among the various components of relationship management system 120. Server systems 120 and/or programs 136 may include a relationship identification subroutine and a relationship advisor subroutine.

The relationship identification subroutine may be adapted to transmit instructions to at least one of the user interface systems instructing at least one of the users to identify at least one steward-entity relationship, to define two or more relationship tiers, to define relationship objectives for each tier, to define each tier as accommodating a number of steward-entity relationships, and to assign one or more steward-entity relationships to a relationship tier. The relationship identification subroutine may be adapted to run on a periodic basis, such as monthly or quarterly, to remind users to update their relationship data. Additionally or alternatively, the relationship identification routine may be initiated by user command such that a user can voluntarily run the routine when his own or when another person's relationship data and/or preferences need to be updated.

As described above, the user interface system may accept data input from a number of different users. The relationship identification routine may be adapted to tag the data being input in response to its prompts, such as the relationship tiers, the relationship objectives, etc., to identify the user that input the data. For example, the relationship identification routine may transmit instructions to one or more user interface systems thereby instructing multiple users to enter data regarding steward-entity relationships. In accordance with the methods described above, in some embodiments it may be desirable to distinguish between the relationship tiers defined by different users and/or to distinguish between steward-entity relationships created by the different users. One example of when this might be desirable is in appropriately identifying which steward-entity relationships correspond to which relationship stewards. Another example is in distinguishing between planned relationships and hypothetical relationships as described above.

The relationship identification routine may be a component of server systems 124, either as part of program 136 or otherwise. Additionally, all or part of the relationship identification routine may be stored or otherwise associated with the user interface systems, such as when the user interface systems are adapted to be remote from the server systems and synchronize periodically when connected to the server systems. The components of the relationship identification routine stored locally may be adapted to prompt the user to input the requisite data and to store the data until synchronization with the server system. Additionally, the local portion of the relationship identification routine may include a portion or all of the data that is stored on the server system database to facilitate remote data entry. In some embodiments, the user may select the amount of data that is stored locally.

The server system additionally includes a relationship advisor routine adapted to analyze at least the data input via the user interface systems in response to the relationship identification routine. The relationship advisor routine may analyze this data, and optionally additional data, to produce one or more relationship maps, such as those described in connection with the methods of the present disclosure. The relationship advisor routine may additionally be adapted to utilize the relationship maps to prepare one or more relationship reports. The one or more relationship reports may be transmitted by the relationship advisor routine to at least one user interface system for display via the data reporting apparatus. Accordingly, relationship management systems 120 according to the present disclosure may advise one or more users. The one or more relationship reports generated by the relationship advisor routine may include one or more of the reports or graphical displays described herein in connection with the methods of the present disclosure.

Similar to the methods described herein, in some embodiments of relationship management systems 120, the relationship advisor routine may be adapted to produce at least one relationship map selected from the group consisting of a planned relationship map, an actual relationship map, and a hypothetical relationship map. The differences between these maps are described above. Consistent with the methods described herein, the hypothetical relationship maps may be produced at least from data entered by one or more auditors or other individuals or groups of individuals having a supervisory function, which may be tagged as such by the relationship identification routine. Similarly, the planned relationship maps may be produced at least from data entered by one or more relationship stewards, which data may be tagged appropriately by the relationship identification routine. When more than one type of relationship map is generated by the relationship advisor routine, the one or more relationship reports may be based at least in part on a comparison of two or more of the planned relationship map, the actual relationship map, and the hypothetical relationship map.

In some embodiments of relationship management systems 120, server systems 124 may further include a relationship monitoring routine. The relationship monitoring routine may be adapted to transmit instructions to at least one of the user interface systems instructing at least one user to input interaction data regarding interactions within one or more steward-entity relationship. The interaction data may include at least interaction evaluation parameters for each interaction and may, additionally or alternatively, include data corresponding to the relationship objective data requested by the relationship identification routine. The data input in response to the instructions from the relationship monitoring routine may be included in the production of the actual relationship map. Additionally or alternatively, data regarding interactions between entities and within steward-entity relationships may be collected from external systems such as contact management systems, call center systems, ordering systems, etc.

A computer-implemented system that implements a program in which relationships between entities are monitored and managed is illustrated in FIG. 9 at 142. Computer-implemented system 142 may be adapted to assist relationship stewards and other users in allocating resources among a plurality of steward-entity relationships. For example, relationship stewards, auditors, or others may use the computer-implemented system to produce one or more relationship reports providing information and/or advice concerning the relationships and their historic, currently planned, or hypothetical trends, projections, and/or allocations of resources. One or more of the methods described herein may be implemented in cooperation with computer-implemented system 142. As illustrated in FIG. 9, the computer-implemented system may include a data input system 144, a monitoring system 146, a server system 148, and a reporting system 150.

Data input system 144 of computer-implemented systems 142 may be adapted for entering information regarding a plurality of entities including one or more relationship stewards. Additionally, the data input system may include a relationship identification routine adapted to instruct at least one user to define at least one steward-entity relationship, to define two or more relationship tiers, to define relationship objectives for each tier, to define each tier as accommodating a number of steward-entity relationships, and to assign one or more steward-entity relationships to a relationship tier. The data input system may include any combination of components, such as keyboards, displays, touch-screen displays, or other data input components. Additionally, data input system 144 may include a plurality of apparatus, such as computers, laptops, personal digital assistants, and the like, for entry of data into the computer-implemented system. As discussed elsewhere herein, the data input system may be adapted to operate remotely from the remainder of computer-implemented system 142 and periodically communicate with the computer-implemented system for exchange, transfer, and/or synchronization of data. Alternatively, data input system 144 may be in communication with server system 148 or other components of computer-implemented system 142 via any acceptable communication methods.

The monitoring system of the present disclosure may be adapted for collecting information regarding interactions between the plurality of entities, including interactions within one or more steward-entity relationships. The information collected may include any type of data and may include data to any level of detail desired. In some applications of systems according to the present disclosure, the information collected may include interaction evaluation parameters for each interaction. The monitoring system, like the data input system, may include keyboards, displays, touch-screen displays, or other data input components. In some embodiments, the monitoring system may also include connections to other systems in an organization, such as ordering systems, customer service phone systems, and the like. Data collected via monitoring systems 146 may be used in preparation of actual relationship maps and reports as discussed herein. Additionally or alternatively, such data may be used to provide additional levels of detail to any other map or report prepared according to the present disclosure.

In computer-implemented systems according to the present disclosure, the server system may be configured to be in communication with the data input system and the monitoring system. As discussed above, these components may be in communication via traditional computer networks, wireless networks, or other methods of communications. The server system may include at least one program and at least one database adapted to receive, store, access, and otherwise manipulate and exploit the information collected from the data input system and the monitoring system.

In some configurations, the program may be adapted to prepare one or more relationship maps according to the present disclosure. The relationship maps may be based at least in part on factors such as the defined relationship tiers, the relationship tier to which the steward-entity relationship is assigned, the collected information regarding the interactions between the plurality of entities, the collected interaction evaluation parameters, and other user-selectable factors. The relationship maps produced by the program may be customizable according to user preferences to include varying levels of detail. Additionally or alternatively, the program may be adapted to produce one or more relationship maps such as planned relationship maps, actual relationship maps, and hypothetical relationship maps.

The program may be further adapted to prepare one or more relationship reports based at least in part on the one or more relationship maps. The relationship reports produced by the server system may be transmitted to at least one user. The relationship reports may be prepared based at least in part on the relationship maps and the data collected from data input system 144 and monitoring system 146. Additionally or alternatively, the relationship reports may be based on a comparison of the various relationship maps, which in some embodiments may include a comparison of two or more of the planned relationship maps, the actual relationship maps, and the hypothetical relationship maps.

The reporting system 150 of the present disclosure may also be in communication with server system 148. The reporting system may be adapted to receive the one or more relationship reports from the server system for presentation to the at least one user. The reporting system may include printers, monitors, and other forms of communicating information to a user. Similar to the data input system and other components of computer-implemented system 142, reporting system 150 may include more than one reporting apparatus and may include a plurality of types of reporting apparatus. For example, reporting system 150 may include both a printer and a monitor or other display screen. Similarly, there may be different reporting apparatus used for displaying different types of reports to different types of users.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

Although the present invention has been shown and described with reference to the foregoing operational principles and preferred embodiments, it will be apparent to those skilled in the art that various changes in form and detail may be made without departing from the spirit and scope of the invention. The present invention is intended to embrace all such alternatives, modifications and variances that fall within the scope of the appended claims.

1. A computerized method of managing relationships, the method comprising:
identifying a plurality of entities and assigning each entity an entity identifier;
designating one or more of the entities as relationship stewards by further assigning each relationship steward a steward identifier;
allowing each relationship steward to identify one or more entities with whom the steward has a relationship to define one or more steward-entity relationships corresponding to the relationship steward, wherein each steward-entity relationship is assigned a relationship identifier;
defining two or more relationship tiers for each relationship steward each tier having a tier identifier, wherein each relationship tier has relationship objectives, and wherein each relationship tier accommodates a number of steward-entity relationships;
allowing each relationship steward to assign the corresponding steward-entity relationships to one of the two or more relationship tiers creating a relationship tier assignment for each relationship;
receiving the entity identifiers, the steward identifiers, the relationship identifiers, the tier identifiers, and the relationship tier assignments into a computerized database;
analyzing the entity identifiers, the steward identifiers, the relationship identifiers, the tier identifiers, and the relationship tier assignments in a computerized system associated with the computerized database to produce a planned relationship map; and
providing feedback based at least in part on the planned relationship map to at least one of the group consisting of an entity, a relationship steward, and an auditor.

2. The method of claim 1, wherein defining two or more relationship tiers includes defining a first tier accommodating the fewest steward-entity relationships, a second tier accommodating a greater number of steward-entity relationships, and one or more additional tiers accommodating progressively greater numbers of steward-entity relationships.

3. The method of claim 2, wherein the first three tiers of the two or more relationship tiers collectively accommodate from about 100 steward-entity relationships to about 250 steward-entity relationships.

4. The method of claim 2, wherein the first tier accommodates from about 10 relationships to about 25 relationships; wherein the second tier accommodates from about 20 relationships to about 75 relationships; and wherein the third tier accommodates from about 70 relationships to about 150 relationships.

5. The method of claim 1, wherein defining two or more relationship tiers includes allowing customized relationship objectives for at least one of the tiers, wherein at least one of the group consisting of an entity, a relationship steward, and an auditor may define the customized relationship objectives.

6. The method of claim 1, wherein the relationship objectives for each defined relationship tier include at least one factor from the group consisting of interaction frequency, interaction quality, interaction duration, and business statistics associated with the steward-entity relationship.

7. The method of claim 1 further comprising producing at least one map from the group consisting of an actual relationship map and a hypothetical relationship map, wherein providing feedback includes providing feedback based at least in part on one or more of the planned relationship map, the actual relationship map, and the hypothetical relationship map.

8. The method of claim 7 wherein producing a hypothetical relationship map comprises:
identifying at least one auditor;
allowing the at least one auditor to identify one or more hypothetical steward-entity relationships between entities and relationship stewards, wherein each hypothetical steward-entity relationship is assigned a hypothetical relationship identifier;
allowing the at least one auditor to assign the hypothetical steward-entity relationships to one of two or more relationship tiers creating a hypothetical relationship tier assignment for each relationship;
receiving the entity identifiers, the steward identifiers, the hypothetical relationship identifiers, the tier identifiers, and the hypothetical relationship tier assignments into a computerized database; and
analyzing the entity identifiers, the steward identifiers, the hypothetical relationship identifiers, the tier identifiers, and the relationship tier hypothetical assignments in a computerized system associated with the computerized database to produce a hypothetical relationship map.

9. The method of claim 7, wherein producing an actual relationship map comprises:
allowing at least two of the plurality of entities to have one or more interactions over time;
recording interaction evaluation parameters for at least some of the interactions over time; and
comparing the interaction evaluation parameters with the relationship objectives of each relationship tier in a computerized system to produce an actual relationship map.

10. The method of claim 9, wherein each interaction has an impact on one or more steward-entity relationships, and wherein recording interaction evaluation parameters includes recording at least a relationship trust account indicator representative of the impact of the interaction on the one or more steward-entity relationships.

11. A relationship management system for assisting relationship stewards in allocating resources among a plurality of steward-entity relationships, the system comprising:
at least one user interface system having at least one data input apparatus adapted to allow one or more users to input data regarding at least one steward-entity relationship, and having at least one data reporting apparatus adapted to display information regarding at least one steward-entity relationship;
a server system including at least one program and at least one database adapted to receive data from at least the at least one user computer and adapted to store data including at least the data input by the one or more users;
wherein the server system includes a relationship identification routine adapted to transmit instructions to at least one of the user interface systems instructing at least one of the users to identify at least one steward-entity relationship, to define two or more relationship tiers, to define relationship objectives for each tier, to define each tier as accommodating a number of steward-entity relationships, and to assign one or more steward-entity relationships to a relationship tier;
wherein the server system includes a relationship advisor routine adapted to analyze the at least one steward-entity relationship, the two or more relationship tiers, the relationship objectives, and the relationship tier assignments for the steward-entity relationships to produce a relationship map, adapted to utilize the relationship map to prepare one or more relationship reports, and adapted to transmit the one or more relationship reports to at least one of the user computers for display on the data reporting apparatus to advise the one or more users; and
a computer network connecting the server system and the at least one user interface system.

12. The relationship management system of claim 11, wherein the at least one user interface system is adapted to receive steward-entity relationship data from at least one user selected from the group consisting of relationship stewards, auditors, and entities.

13. The relationship management system of claim 12, wherein the relationship identification routine is adapted to tag the steward-entity relationships, the relationship tiers, the relationship objectives, the tier accommodation limits, and the steward-entity relationship tier assignments to identify the user that input the data.

14. The relationship management system of claim 13, wherein the relationship advisor routine is adapted to produce at least one relationship map from the group consisting of a planned relationship map, an actual relationship map, and a hypothetical relationship map.

15. The relationship management system of claim 14, wherein the one or more relationship reports is based at least in part on a comparison of two or more of the planned relationship map, the actual relationship map, and the hypothetical relationship map to advise the user of differences between the compared maps.

16. The relationship management system of claim 14, wherein the hypothetical relationship map is produced at least from data tagged as being input by one or more auditors, and wherein the planned relationship map is produced at least from data tagged as being input by one or more relationship stewards.

17. The relationship management system of claim 14, wherein the server further includes a relationship monitoring routine adapted to transmit instructions to at least one of the user interface systems instructing at least one user to input interaction data regarding interactions within one or more steward-entity relationship; wherein the input interaction data includes interaction evaluation parameters for each interaction; and wherein the actual relationship map is produced at least from interaction data.

18. A computer-implemented system that implements a program in which relationships between entities are monitored and managed to assist relationship stewards in allocating resources among a plurality of steward-entity relationships, the system comprising:
a data input system for entering information regarding a plurality of entities including one or more relationship stewards and including a relationship identification routine adapted to instruct at least one user to define at least one steward-entity relationship, to define two or more relationship tiers, to define relationship objectives for each tier, to define each tier as accommodating a number of steward-entity relationships, and to assign one or more steward-entity relationships to a relationship tier;
a monitoring system for collecting information regarding interactions between the plurality of entities, including interactions within one or more steward-entity relationships, wherein the information collected includes interaction evaluation parameters for each interaction;
a server system in communication with the data input system and the monitoring system including at least one program and at least one database adapted to access the information collected from the data input system and the monitoring system, wherein the program is adapted to prepare a relationship map based at least in part on one or more factor selected from the group consisting of the defined relationship tiers, the relationship tier to which the steward-entity relationships are assigned, the collected information regarding the interactions between the plurality of entities, the collected interaction evaluation parameters, and a user-selectable factor, and wherein the program is further adapted to prepare a relationship report based at least in part on the relationship map and to transmit the relationship report to at least one user; and
a reporting system in communication with the server system adapted to receive the relationship report from the server system for presentation to the at least one user.

19. The system of claim 18, wherein the server system is adapted to produce one or more relationship maps selected from the group consisting of planned relationship maps, actual relationship maps, and hypothetical relationship maps.

20. The system of claim 19, wherein the server system is adapted to produce one or more relationship reports based at least in part on a comparison of two or more of the planned relationship maps, the actual relationship maps, and the hypothetical relationship maps to advise the user of differences between the compared relationship maps.

21. The system of claim 19, wherein the hypothetical relationship maps are produced at least from information entered into the data input system by one or more auditors; wherein the planned relationship maps are produced at least from information entered into the data input system by one or more relationship stewards; and wherein the actual relationship maps are produced at least from information collected from the monitoring system.
